(19) United States
(12) Patent Application Publication
(10) Pub. No.: US 2005/0010959 A1
(43) Pub. Date: Jan. 13, 2005

(54) Digital broadcast receiving apparatus and control method therefor

(75) Inventor: Takashi Kitamura, Fukaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/898,984

(22) Filed: Jul. 27, 2004

Related U.S. Application Data
(62) Division of application No. 09/946,617, filed on Sep. 6, 2001.

(30) Foreign Application Priority Data
Apr. 20, 2001 (JP) 2001-122886

(51) Int. Cl. H04N 5/91; H04N 7/173

(52) U.S. Cl. 725/115; 386/83

(57) ABSTRACT

This invention provides a digital broadcast receiving apparatus which receives a digital broadcast, generates an analog video signal, and extracts content information from the received digital broadcast. The content information is multiplexed on the analog video signal as closed caption data and output.

### CROSS-REFERENCE TO RELATED APPLICATIONS

This is a Divisional Application of U.S. application Ser. No. 09/946,617, filed Sep. 6, 2001, which is based upon and claims the benefit of priority to Japanese Patent Application No. 2001-122886, filed Apr. 20, 2001, the entire contents of both of which are incorporated herein by reference.

### BACKGROUND OF THE INVENTION

1. Field of the Invention

The present invention relates to a digital broadcast receiving apparatus for receiving, e.g., digital television broadcast using a satellite and a control method therefor.

2. Description of Related Art

As is known, digital television broadcast has been put into practice recently. In this digital television broadcast, program information is broadcast, and additionally, various kinds of content information are distributed by data broadcasting.

Content information contain contents irrelevant to a program to be broadcast or contents related to a program to be broadcast (e.g., the program title, broadcast date, program information, and the like).

A receiving apparatus for receiving such digital television broadcast can also display content information by OSD (On Screen Display) in decoding and displaying received program information.

In a system for broadcasting both program information and its content information, how to process content information, i.e., digital data in converting received program information into an analog video signal and recording it on a tape by a VTR (Video Tape Recorder) or the like poses a problem.

To solve this problem, in recent years, a standard called a video ID has been set as described in, e.g., Technical Report of Electronic Industries Association of Japan, “Video ID Signal Transmission Scheme Using VBI (525P System), enacted March, 1998”.

In this video ID standard, digital information is arranged in the effective video portion of the 41st line of the VBI (Vertical Blanking Interval) of a luminance signal, thereby recording the information.

This video ID standard has been initially set to transmit screen aspect ratio information along with the proliferation of wide screens with an aspect ratio of 16:9 and then revised for the other application purposes, i.e., to transmit various kinds of information such as the type of information to be transmitted and code assignment of information bits.

The video ID standard surely allows to multiplex digital information on an analog video signal and record it, as analog information, on a recording medium such as a tape by a VTR.

In the video ID standard, however, since digital information to be multiplexed on an analog video signal is data for a video index, the digital information cannot be played back and displayed unless a special player having a decoding function compatible with the video ID standard is used.

### SUMMARY OF THE INVENTION

The present invention has been made in consideration of the above situation, and has as its object, to provide a digital broadcast receiving apparatus capable of easily playing back content information multiplexed on an analog video signal without using any device with a special function, and a control method therefor.

According to the present invention, there is provided a digital broadcast receiving apparatus which receives a digital broadcast, generates an analog video signal, and extracts content information from the received digital broadcast, comprising a control section multiplexing the content information on the analog video signal as closed caption data, and outputting the content information.

According to the present invention, there is also provided a control method for a digital broadcast receiving apparatus which receives a digital broadcast, generates an analog video signal, and extracts content information from the received digital broadcast, comprising the control step of multiplexing the content information on the analog video signal as closed caption data, and outputting the content information.

According to the above arrangement and method, since content information is multiplexed on an analog video signal as closed caption data and output, the content information multiplexed on the analog video signal can easily be played back and displayed without using any device with a special function.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram for explaining a digital STB according to the first embodiment of the present invention;

FIG. 2 is a block diagram for explaining a digital STB according to the second embodiment of the present invention;

FIG. 3 is a block diagram for explaining a digital STB according to the third embodiment of the present invention;

FIG. 4 is a block diagram for explaining a digital television receiver according to the fourth embodiment of the present invention;

FIG. 5 is a block diagram for explaining a digital STB according to the fifth embodiment of the present invention; and

FIG. 6 is a block diagram for explaining a digital STB according to the sixth embodiment of the present invention.

### DETAILED DESCRIPTION OF THE INVENTION

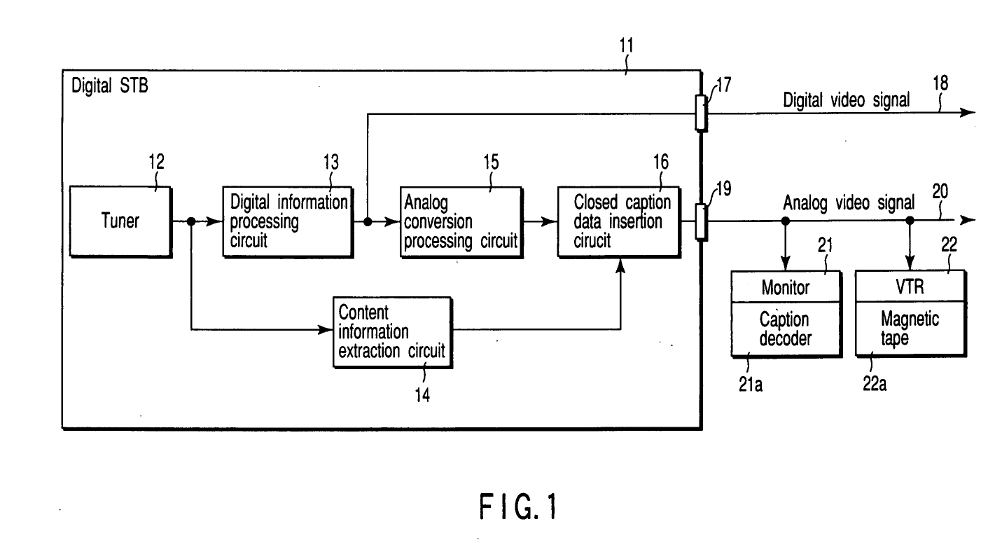

The first embodiment of the present invention will be described below in detail with reference to the accompanying drawing. FIG. 1 is a block diagram showing the schematic arrangement of a digital STB (Set Top Box) 11 to be described in the first embodiment.

In this digital STB 11, a tuner 12 extracts digital information of a desired channel from a received digital television broadcast wave and outputs the digital information to a digital information processing circuit 13 and content information extraction circuit 14.

The digital information processing circuit 13 extracts a video information component (also including an audio information component) from the received digital information, reconstructs the component into a digital video signal, and outputs the signal to an analog conversion processing circuit 15.

The analog conversion processing circuit 15 converts the received digital video signal into an analog video signal of NTSC (National Television System Committee) scheme and outputs the signal to a closed caption data insertion circuit 16.

The digital video signal generated by the digital information processing circuit 13 is guided to a digital video output terminal 17 and output from the digital STB 11 through a line 18 connected to the digital video output terminal 17.

The content information extraction circuit 14 extracts and reconstructs a content information component from the received digital information and outputs the component to the closed caption data insertion circuit 16.

The closed caption data insertion circuit 16 multiplexes, as closed caption data, the content information supplied from the content information extraction circuit 14 on a line 21 of the vertical blanking interval of the analog video signal supplied from the analog conversion processing circuit 15.

The analog video signal with the content information multiplexed by the closed caption data insertion circuit 16 is guided to an analog video output terminal 19 and output from the digital STB 11 through a line 20 connected to the analog video output terminal 19.

A monitor 21 and VTR 22 are connected to the line 20. The analog video signal output to the line 20 is displayed on the screen of the monitor 21.

In this case, the content information multiplexed on the analog video signal can be decoded by a caption decoder 21a of the monitor 21 and displayed on the screen in synchronism with the video.

The analog video signal output to the line 20 is also recorded on a magnetic tape 22a by the VTR 22 together with the content information multiplexed as closed caption data.

Even in displaying on the monitor 21 the analog video signal played back from the magnetic tape 22a by the VTR 22, the content information multiplexed on the analog video signal is decoded by the caption decoder 21a of the monitor 21 and displayed on the screen.

According to the above-described first embodiment, the content information is multiplexed, as closed caption data, on the line 21 of the vertical blanking interval of the analog video signal.

Hence, the content information can easily be played back and displayed using the caption decoder 21a of the VTR 22 without using any device with a special function.

The monitor 21 normally has a function of automatically controlling the closed caption data display position on the screen not to overlap characters.

For this reason, even when content information is multiplexed as closed caption data on an analog video signal that contains actual closed caption data to be used as a subtitle, the subtitle display is not adversely affected.

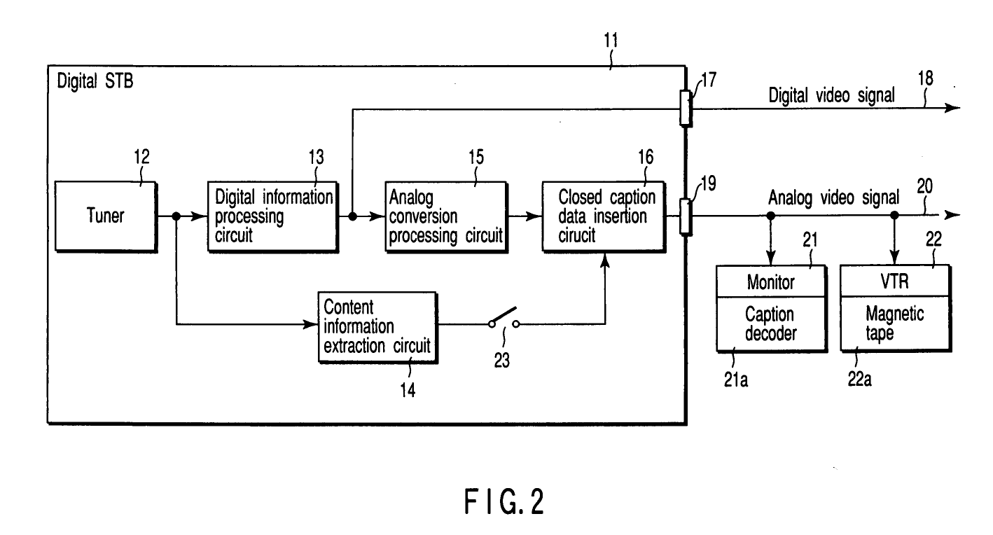

FIG. 2 is a block diagram showing the second embodiment of the present invention. The same reference numerals as in FIG. 1 denote the same parts in FIG. 2. A switch 23 that can be ON/OFF-controlled by a user is inserted between a content information extraction circuit 14 and a closed caption data insertion circuit 16.

When the switch 23 is turned on, content information output from the content information extraction circuit 14 can be guided to the closed caption data insertion circuit 16 and multiplexed on an analog video signal, as described above.

On the other hand, when the switch 23 is turned off, the content information output from the content information extraction circuit 14 is not guided to the closed caption data insertion circuit 16 and not multiplexed on the analog video signal.

That is, instead of always multiplexing the content information on the analog video signal, the user can select the state wherein the content information is to be multiplexed on the analog video signal or the state wherein the content information is not to be multiplexed on the analog video signal.

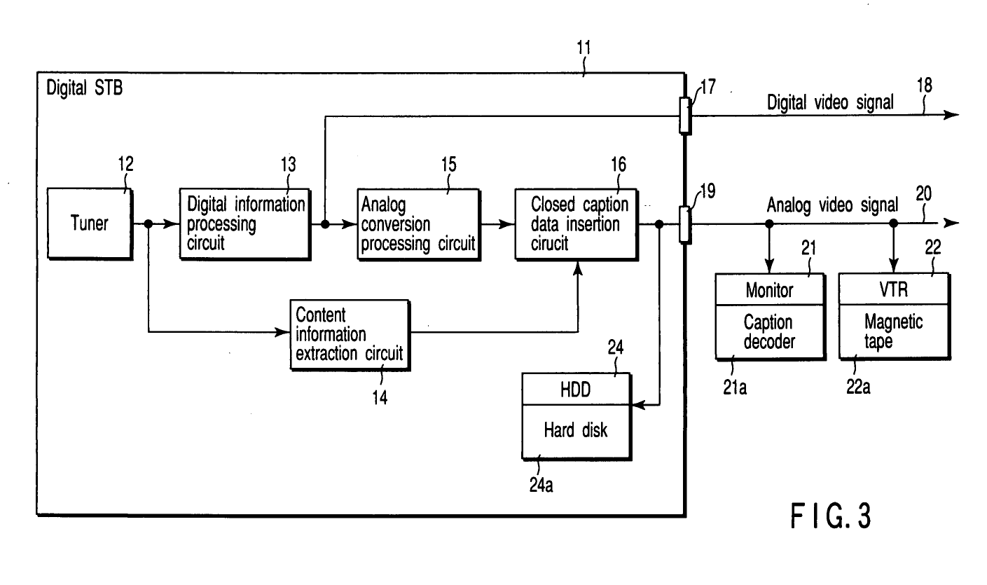

FIG. 3 is a block diagram showing the third embodiment of the present invention. The same reference numerals as in FIG. 1 denote the same parts in FIG. 3. A digital STB 11 incorporates an HDD (Hard Disk Drive) 24.

The HDD 24 can convert an analog video signal having content information multiplexed, which is output from a closed caption data insertion circuit 16, into digital information and record it on a hard disk 24a.

When the digital STB 11 incorporates the HDD 24, for example, a program that is being watched can be temporarily recorded, and later, stored on a tape or disk as needed. Multiple functions can be offered to a user.

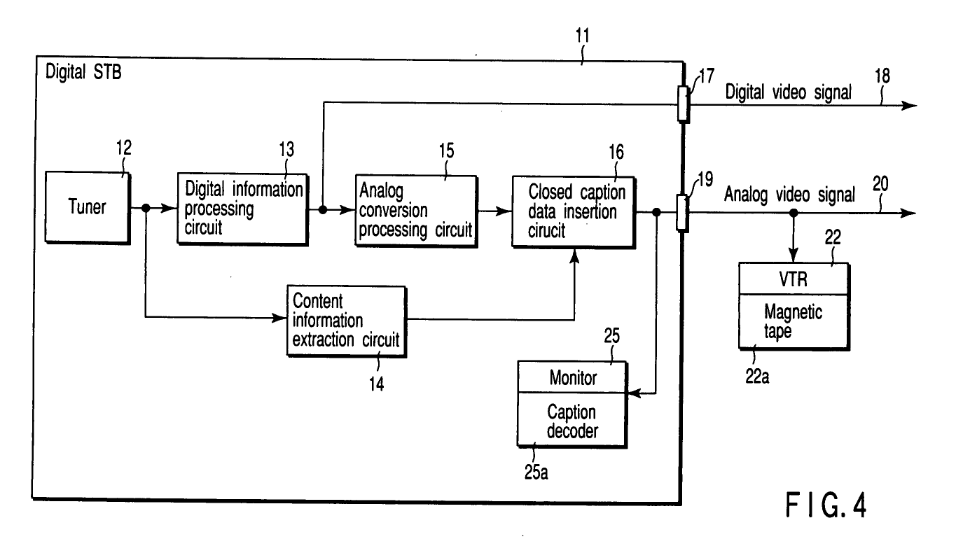

FIG. 4 is a block diagram showing the fourth embodiment of the present invention. The same reference numerals as in FIG. 1 denote the same parts in FIG. 4. A monitor 25 having a caption decoder 25a is incorporated in the above-described digital STB 11, thereby constructing a digital television receiver 26.

In this case, an analog video signal having content information multiplexed, which is output from a closed caption data insertion circuit 16, is supplied to the monitor 25 so that the program and content information are displayed.

As described above, the present invention can be applied not only to the digital STB 11 but also to the digital television receiver 26. When the digital television receiver 26 is used, a monitor 21 need not be connected to a line 20 to which the analog video signal is output.

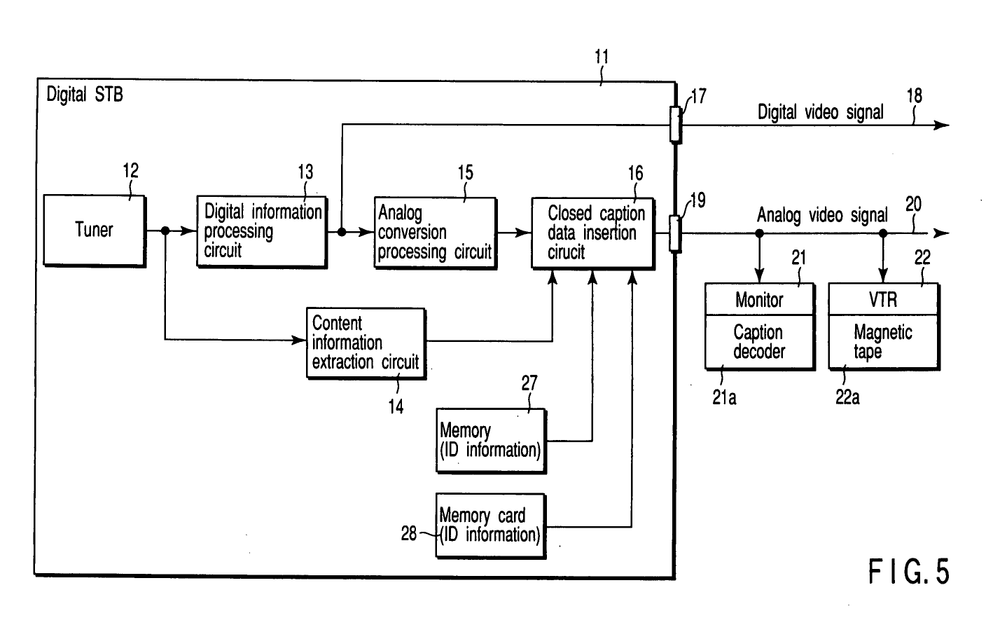

FIG. 5 shows the fifth embodiment of the present invention. The same reference numerals as in FIG. 1 denote the same parts in FIG. 5. A digital STB 11 incorporates a memory 27 which stores the ID (identify) of its own.

A memory card 28 as a portable recording medium held by a user can be attached to the digital STB 11. The memory card 28 stores ID information unique to the user who holds the card.

A closed caption data insertion circuit 16 multiplexes, on an analog video signal, both or one of the ID information stored in the memory 27 and the ID information stored in the memory card 28 as closed caption data together with content information.

According to the fifth embodiment, even when an analog video signal output from the digital STB 11 is illegally copied and put onto the market, the digital STB 11 used for the illegal copy or the user who is liable for the illegal copy can be specified by displaying the ID information multiplexed on the analog video signal as closed caption data.

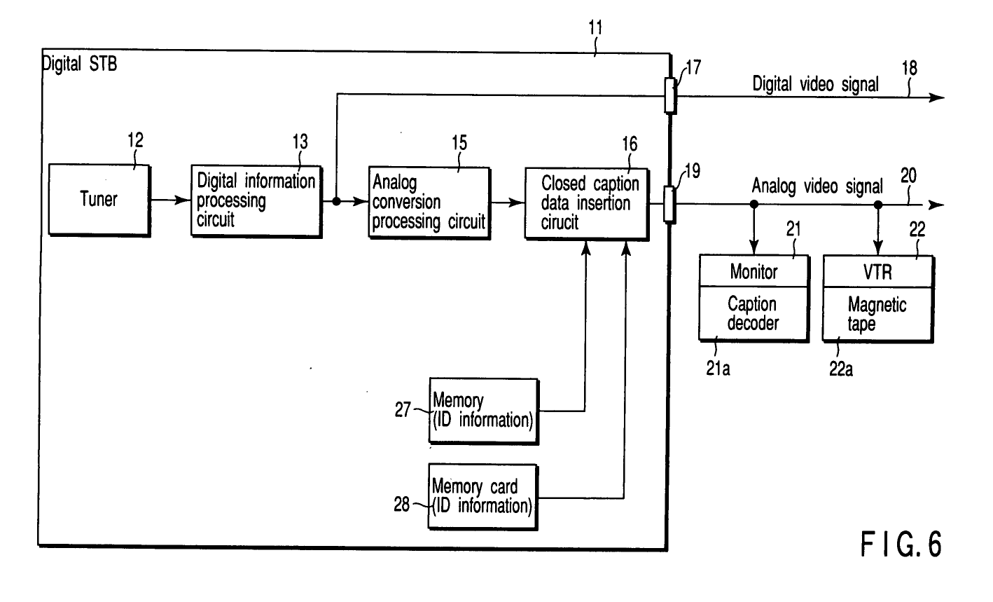

FIG. 6 shows the sixth embodiment of the present invention. The same reference numerals as in FIG. 1 denote the same parts in FIG. 6. A closed caption data insertion circuit 16 multiplexes, on an analog video signal, both or one of ID information stored in a memory 27 and ID information stored in a memory card 28 as closed caption data. With this arrangement as well, the same effect as in the fifth embodiment can be obtained.

A known technique related to a measure against illegal copy is disclosed in Jpn. Pat. Appln. KOKAI Publication No. 2000-358227. In this technique, an analog video signal is scrambled, and key information/authentication information and the like are exchanged between a sender and a receiver. This technique does not suggest the technique described in the fifth or sixth embodiment, i.e., multiplexing ID information on an analog video signal as closed caption data.

The techniques described in the first to sixth embodiments can be arbitrarily selected and appropriately combined within the range without hindrance.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A digital broadcast receiving apparatus, comprising:
a tuner, to which a received digital broadcast signal is input and which is configured to extract digital information of a predetermined channel from the input digital broadcast signal;
a digital information processing circuit, to which the digital information extracted by the tuner is input and which is configured to extract a video information component from the input digital information and reconstruct a digital video signal;
a digital video output terminal, to which the digital video signal reconstructed by the digital information processing circuit is input and which is configured to output the input digital video signal;
an analog conversion processing circuit, to which the digital video signal reconstructed by the digital information processing circuit is input and which is configured to convert the input digital video signal to an analog video signal;
a memory incorporated in the digital broadcast receiving apparatus and configured to prestore identification information unique to the digital broadcast receiving apparatus;
a closed caption data inserting circuit, which reads the identification information prestored in the memory, to which the analog video signal output from the analog conversion processing circuit is input, and which is configured to multiplex the identification information read from the memory on the input analog video signal as closed caption data; and
an analog video output terminal, to which the analog video signal, with the identification information multiplexed thereon by the closed caption data inserting circuit as the closed caption data, is input, and which is configured to output the input analog video signal.

2. A digital broadcast receiving apparatus according to claim 1, further comprising a monitor, to which the analog video signal output from the analog video output terminal is input, and which comprises a caption decoder to decode the identification information from the input analog video signal and displays the identification information decoded by the caption decoder.

3. A digital broadcast receiving apparatus according to claim 1, further comprising a recorder, to which the analog video signal output from the analog video output terminal is input, and which records the input analog video signal along with the identification information multiplexed as the closed caption data.

4. A digital broadcast receiving apparatus according to claim 1, further comprising a contents information extracting circuit, to which the digital information extracted by the tuner is input, and which is configured to reconstruct a contents information component from the input digital information,
wherein the closed caption data inserting circuit multiplexes the contents information reconstructed by the contents information extracting circuit on the input analog video signal as the closed caption data along with the identification information read from the memory.

5. A digital broadcast receiving apparatus, comprising:
a receiver configured to receive a digital broadcast signal;
a processor configured to reconstruct a digital video signal from the digital broadcast signal received by the receiver;
a digital output terminal configured to output the digital video signal reconstructed by the processor;
a converter configured to convert the digital video signal reconstructed by the processor to an analog video signal;
a storage configured to store identification information unique to the digital broadcast receiving apparatus;
a multiplexer configured to multiplex the identification information stored in the storage on the analog video signal output from the converter as closed caption data; and
an analog output terminal configured to output the analog video signal on which the identification data is multiplexed as the closed caption data by the multiplexer.
